(19) United States
(12) Patent Application Publication
(10) Pub. No.: US 2009/0228935 A1
(43) Pub. Date: Sep. 10, 2009

(54) ENERGY AND MULTIMEDIA DATA TRANSPORT NETWORK AND RAIL

(75) Inventor: Jean-Pierre Delwaulle, Brest (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/398,086

(22) Filed: Mar. 4, 2009

(30) Foreign Application Priority Data
Mar. 4, 2008 (FR) 0801183

(51) Int. Cl. H04N 7/18

(52) U.S. Cl. 725/76

(57) ABSTRACT

The present invention relates to an energy and multimedia data transport network and rail notably intended for embedded multimedia equipment on board aircraft. The network is connected with at least one data server and at least one energy supply box. The network includes: one or more energy and data transport rails; at least a first interconnection box to interconnect a first energy and data transport rail, the data server and the energy supply box; and a connection module for each terminal or group of multimedia terminals, the connection module including a cable to link a predetermined point of the rail to the associated multimedia terminal or terminals.

### CROSS-REFERENCE TO RELATED APPLICATION

The present application claims the benefit of French Patent Application Serial No. 0801183, filed Mar. 4, 2008 which is hereby incorporated by reference in its entirety.

### BACKGROUND OF THE INVENTION

The present invention relates to an energy and multimedia data transport network and rail notably intended for embedded multimedia equipment on board aircraft. The invention comes within the framework of a package of entertainments offered to passengers of a long-haul flight for example.

### BRIEF DESCRIPTION OF THE PRIOR ART

Nowadays, one of a traveller's concerns on a long-haul aircraft is notably boredom during the long hours of flight. Travellers, passengers on long-haul aircraft, when they become bored, have a tendency to move around the aircraft a great deal and to call upon the onboard flight personnel, sometimes to the detriment of the safety of the other passengers. It is therefore important to be able to divert the passengers of the aircraft. Moreover, the quality of the services offered in the course of the flight, both for economy class and for business class, may lead a traveller to decide in favour of one airline or another. It is therefore important for an airline to offer a quality service, for example a multimedia service.

Commonly proposed diversion solutions are communal diversions, for example:
a single film showing on a communal screen in economy class;
a few films played simultaneously on several video players and viewable on an individual screen for each passenger in business class;
neutral audio programmes;
a screen broadcasting the progress of the aircraft on its voyage.

Passengers are increasingly resorting to portable personal solutions to occupy the journey time, for example audio players, video players, computers, video games consoles.

It is therefore important for the airlines, when they wish to stand out from competitor airlines, to do so in terms of in-flight services offered, by allowing notably the travellers to travel light, or by providing multimedia services of a level equivalent to domestic multimedia services.

In order to offer a customized multimedia package, even in economy class, it is preferable in practice:
to feed each passenger seat with enough energy to supply either an individual screen associated with autonomous processing means as well as with user interface peripherals, or a portable micro-computer belonging to the passenger;
to provide, for each seat, a sufficient bandwidth of computer network type in the incoming communication direction and in the outgoing communication direction, thus making it possible to convey data related to individual multimedia services.

Onboard an aircraft, certain constraints prevent the use of technologies commonly used in a domestic or office environment such as: Ethernet networks, 220-volt mains sockets. These constraints are notably:
electrical safety constraints which make it preferable to provide electrical energy at very low safety voltage or VLSV;
air-conditioning constraints: each watt consumed is retroceded in thermal form to the cabin of the aircraft, increasing the temperature of the cabin;
usage constraints: all the seats of an aircraft should be able to be replaced with other seats in a very short time span with a possible change of spacing between the seats and between rows of seats; this is notably the case when a configuration of an aircraft is changed for a charter flight or for a flight with three classes.

The solutions currently used onboard aircraft in order to link the multimedia terminals associated with each seat use notably connectors secured to the structure of the aircraft. Each connector makes it possible to link a box to a data and energy distribution network structure of the aircraft. The box thereafter allows the connection of a set of terminals associated with the seats of one and the same row for example. Linkup of the box and terminals can be performed by wires running along the flooring of the aircraft, for example under the carpet. The wires can thereafter rise to the terminals by passing through the structure of the seat for example. For the higher classes, one box per seat can be used, the box being for example integrated into the structure of the seat.

The use of connectors secured to the structure of the aircraft makes it difficult or indeed impossible to change seat configurations in the aircraft. Specifically, the arrangement of the fixed connectors is optimal in terms of cabling for a particular configuration of the seats in the aircraft and notably for just one spacing, or just one gap, between the rows. Moreover, an objective of a change of gap between the rows is to vary the number of rows by at least one unit. Connectors may then be unused and therefore exposed to deterioration caused by dust, impacts, liquids.

A first solution may be to mount connectors on a mobile support. This first solution makes it preferable to modify the structure of the aircraft, thus complicating the architecture of the floor of the aircraft cabin. T his therefore generates cost overheads in the production of the aircraft. Moreover, risks of seizing of the mobile support may render the support unusable after a short time. A mobile support such as this therefore requires considerable and expensive maintenance.

A second solution is to mount the connectors at the end of flexible cables. The flexible cables notably pose reliability problems in the case where a connector is located far from a seat: the cables may be impaired during changes of seats, or by the feet of the passengers.

Such first and second solutions also exhibit the drawback of using many cables, thus limiting the capabilities of the network structure in terms of data and power transport, with the risk of greatly increasing the dead weight.

A third solution based on optical fibres can also be implemented. However, optical fibres do not make it possible to convey power and are very fragile, so increasing the maintenance costs of the third solution.

A fourth solution using a radio network makes it possible to partly circumvent cabling problems. Specifically, the power radiated by the radio network does not make it possible to supply the terminals, floor cabling is therefore required. Moreover, the total bandwidth of a radio network for the entire aircraft may be insufficient to transmit, for example, a large number of films simultaneously. Furthermore, the electromagnetic spectrum existing in the environment of an aircraft is by nature unique, even though it is shared by equipment that is vital for air safety. Use of radio networks may also give rise to risks of disturbance to the aircraft flight equipment. Moreover, the standards in regard to electromagnetic radiation are very strict in certain countries. A radio network therefore cannot be embedded onboard all aircraft in a standard manner. Finally, such a radio network might also not be satisfactory in terms of services offered, on account notably of the fact that the available bandwidth is too low.

### SUMMARY OF THE INVENTION

An aim of the invention is notably to distribute energy to multimedia equipment as well as to allow information exchange between several items of client equipment or between an item of client equipment and an item of server equipment. For this purpose, the subject of the invention is an energy and data transport network. The energy and data transport network is intended for multimedia terminals. The said network is connected with at least one data server and at least one energy supply box. The network comprises notably:
one or more energy and data transport rails;
at least one first interconnection box between a first energy and data transport rail and:
   the data server;
   the energy supply box;
a connection module for at least one multimedia terminal.
   The first interconnection box performs notably a first routing of the data between the data server and the first rail, a second routing of energy between the energy supply box and the first rail.
   The said connection module is for example connected at an arbitrary point of the rail, a cable ensuring a link between the connection module and the multimedia terminal.

The energy and data transport network may comprise:
at least one second energy and data transport rail;
a second interconnection box between the first rail and the second rail. The second interconnection box performs notably a data and energy routing between the first rail and the second rail.

The interconnection boxes may be connected to an end of a rail.

The connection module comprises notably:
a connection probe introduced into an energy and data transport rail, the said connection probe being notably:
   mechanically and electrically in contact with the interior of the rail;
   able to collect energy and data on the rail;
   able to transfer data on the rail;
an electronic box:
   comprising interfaces for amplifying and shaping the data;
   ensuring the transmission of the energy collected by the connection probe.

The rail may be made of a contoured material comprising a slot over the whole of its length.

The rail has for example a U-shaped cross section.

The slot of the rail may be oriented towards a floor.

The slot of the rail may be closed by two lips made for example of a resilient material.

The slot may notably comprise a notching system.

The rail comprises at least two electrical conductors separated by an insulant (i.e., an insulator). A first electrical conductor is for example at a reference potential and a second electrical conductor transmits a variable voltage.

The connection probe may comprise at least two contacts. Each contact is mechanically and electrically in contact with one of the electrical conductors.

The rail may be a rail with open coaxial structure.

The rail with coaxial structure may comprise an elastic external structure encompassing an internal structure comprising the two conductors and the insulant. The two conductors and the insulant may be able to deform when the two contacts of the connection probe are introduced into the rail with coaxial structure.

The rail may be a surface-wave rail comprising one or more strips of piezo-electric materials transmitting the data through one or more surface waves.

The connection probe may comprise one or more transducers able to be in contact with the piezo-electric strip or strips.

The rail may be a rail with waveguide structure.

The rail with waveguide structure may comprise two bars composed notably of dielectric materials leaving for example free an access to the electrical conductors for two coaxial contacts of a coaxial connection probe with piston. The two coaxial contacts are notably insulated from one another by a coaxial insulant.

The energy and data transport network may be able to supply data and energy to touch-screens.

The energy and data transport network may be able to supply data and energy to personal portable computers.

The energy and data transport network may be connected to an external network.

The energy and data transport network may be mounted onboard an aircraft.

The first and second rails may be mounted on a floor of a cabin of the aircraft, for example in a manner substantially parallel to fixing rails of rows of passenger seats.

The invention has notably the main advantages of exhibiting a modular structure adaptable to various configurations and having high upgrade potential. The invention also presents the advantage of being inexpensive to implement.

### BRIEF DESCRIPTION OF THE DRAWINGS

Other characteristics and advantages of embodiments of the invention will become apparent with the aid of the description which follows, given by way of nonlimiting illustration in conjunction with the appended drawings which represent:

FIG. 1: a network of multimedia connections according to the prior art;

FIG. 2: two configurations of multimedia connections according to the prior art;

FIG. 3: a network of multimedia connections according to an embodiment of the invention;

FIG. 4: two configurations of multimedia connections according to an embodiment of the invention;

FIG. 5a: a first exemplary multimedia connection rail according to an embodiment of the invention;

FIG. 5b: a second exemplary multimedia connection rail according to an embodiment of the invention;

FIG. 5c: a third exemplary multimedia connection rail according to an embodiment of the invention;

FIG. 5d: an example of a first connection probe on a multimedia connection rail according to an embodiment of the invention;

FIG. 6a: a conducting rail with coaxial structure according to an embodiment of the invention;

FIG. 6b: the conducting rail with coaxial structure with a second connection probe according to an embodiment of the invention;

FIG. 7a: a rail with waveguide structure according to an embodiment of the invention;

FIG. 7b: the rail with waveguide structure according to an embodiment of the invention filled with a dielectric;

FIG. 7c: the rail with waveguide structure with a third connection probe according to an embodiment of the invention;

FIG. 8a: a surface-wave rail according to an embodiment of the invention;

FIG. 8b: the surface-wave rail with a fourth connection probe according to an embodiment of the invention.

### DETAILED DESCRIPTION

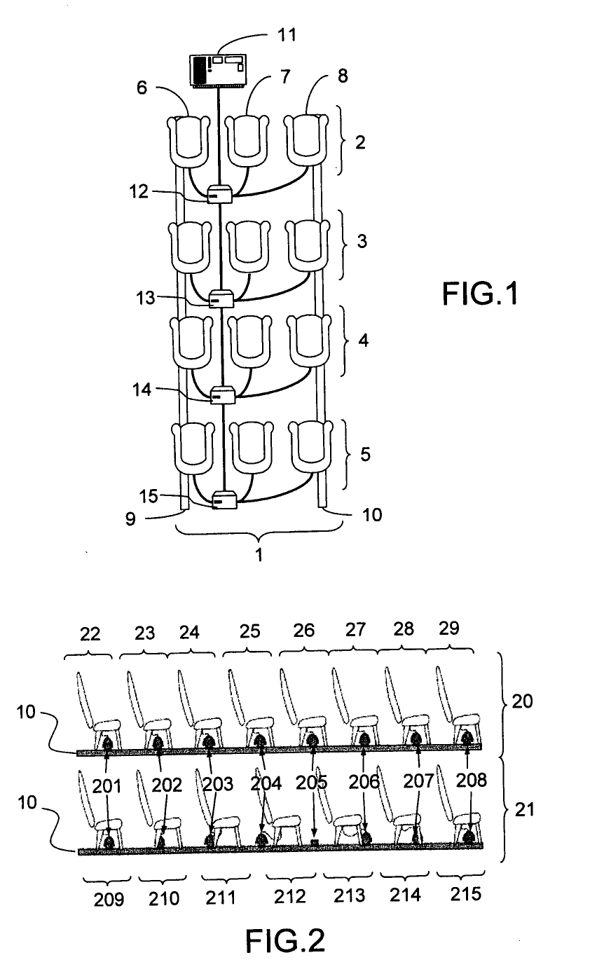

FIG. 1 represents in a schematic manner a network of multimedia connections according to the prior art embedded onboard an aircraft that can transport passengers. For the example, FIG. 1 depicts a first column 1 comprising four rows 2, 3, 4, 5. Each row 2, 3, 4, 5 may comprise, as in FIG. 1, three seats 6, 7, 8. Each row 2, 3, 4, 5 is for example mounted on two rails 9, 10. Thus a row may be composed of two, three or more seats 6, 7, 8 according to types of configurations desired for the aircraft. A distance between two successive rows 2, 3, 4, 5 may also depend on the desired configuration for transporting passengers. Thus a configuration corresponding to an economy class may comprise three seats 6, 7, 8 in each row, as represented in FIG. 1. A configuration corresponding to a higher class than economy class, such as business class for example, may comprise only two seats 6, 7.

A network of multimedia connections according to the prior art may comprise notably a first multimedia data server 11. The first multimedia data server 11 may be connected to a first box 12 ensuring the distribution of the data originating from the first server 11 to terminals, that are not represented in FIG. 1, present notably in the seats 6, 7, 8. The multimedia terminals may take the form of a screen, encased in the back of a seat 6, 7, 8 of a first row 2. The screen is then visible to a passenger of the row seated on a seat of a second row 3 situated behind the first row 2. The multimedia terminals may also comprise means for selecting a multimedia entertainment such as a film. The selection means, not represented in FIG. 1, may be integrated into the screen, as in a touch-screen. The first box 12 makes it possible to supply multimedia data to a second box 13. The second box 13 makes it possible to supply multimedia data to multimedia terminals associated with seats of the second row 3. In the same manner, the second box 13 can supply multimedia data to a third box 14, the said third box 14 supplying multimedia data to terminals associated with seats of a third row 4. The third box 14 can also supply multimedia data to a fourth box 15, the fourth box 15 then supplies multimedia data to terminals associated with seats of a fourth row 5. And so on and so forth until the various multimedia terminals of a set of seats distributed within the cabin of the aircraft are supplied.

The connections between the boxes 12, 13, 14, 15 may be effected by wires running along the flooring of the cabin of the aircraft, concealed under the carpet. The boxes 12, 13, 14, 15 are notably fixed to the flooring of the cabin of the aircraft. Connections from the boxes 12, 13, 14 to the terminals associated with the seats may be made directly between each seat 6, 7, 8 and the box 12, 13, 14 of the row 2, 3, 4, 5 in which the seat 6, 7, 8 is situated. For example, the first box 12 may be connected to a multimedia terminal of a first seat 6 of the first row 2 by a cable passing through the structure of the first seat 6. In the same manner, the first box 12 may be connected to a multimedia terminal of a second seat 7 and to a multimedia terminal of a third seat 8.

This type of network of multimedia connections according to the prior art is not adaptable as a function of the configuration of the aircraft. Notably, a change of configuration may render the network of multimedia connections completely unusable.

Moreover the considerable number of cables used has the main drawback of limiting the transport capabilities notably as regards data. The cables may also be prone to multiple deteriorations, thus posing problems of reliability with the network of connections according to the prior art.

FIG. 2 represents two possible configurations 20, 21 of a cabin of an aircraft with a communication network according to the prior art. A first configuration 20 may be a configuration of economy class type for example. A second configuration 21 may be a configuration of business class type for example.

In the first configuration 20, eight first rows 22, 23, 24, 25, 26, 27, 28, 29 are represented for the example. The terminals of each seat of each of the first rows 22, 23, 24, 25, 26, 27, 28, 29 are connected to the network by a connector 201, 202, 203, 204, 205, 206, 207, 208. The connectors 201, 202, 203, 204, 205, 206, 207, 208 are fixed to the structure of the cabin of the aircraft. In the first configuration 20, each of the first rows 22, 23, 24, 25, 26, 27, 28, 29 has a dedicated connector 201, 202, 203, 204, 205, 206, 207, 208. Each connector 201, 202, 203, 204, 205, 206, 207, 208 is positioned so as to be aligned with one of the first rows 22, 23, 24, 25, 26, 27, 28, 29 corresponding thereto. Thus, the spacing between each connector 201, 202, 203, 204, 205, 206, 207, 208 is substantially equal to the spacing between each of the first rows 22, 23, 24, 25, 26, 27, 28, 29. For example, a fifth row 22 is associated with a first connector 201 aligned with the fifth row 22. The first connector 201 serves notably to connect the terminals of the seats of the fifth row 22 to a fifth box associated with the fifth row 22, like the fourth box 15, represented in FIG. 1. The connection between the terminals of the seats of the fifth row 22 and the first connector 201 can be made by passing through a structure carrying the seats of the fifth row 22. The network of multimedia connections is therefore adapted to the first configuration 20.

A change of configuration of the cabin of the aircraft may give the second configuration 21. In the second configuration 21, the number of second rows 209, 210, 215, 216, 217, 218, 219 is decreased with respect to the number of first rows 22, 23, 24, 25, 26, 27, 28, 29 of the first configuration 20. The connectors 201, 202, 203, 204, 205, 206, 207, 208 fixed in the structure of the cabin are, in the second configuration 21, misaligned. Specifically, the spacing between the second rows 209, 210, 215, 216, 217, 218, 219 is greater than the spacing between the connectors 201, 202, 203, 204, 205, 206, 207, 208. This induces a misalignment of the second rows 209, 210, 215, 216, 217, 218, 219 and of the connectors 201, 202, 203, 204, 205, 206, 207, 208. For example a second connector 205 may not be linked to any second row 209, 210, 215, 216, 217, 218, 219. The other connectors 201, 202, 203, 204, 206, 207, 208 may be connected to each of the second rows 209, 210, 215, 216, 217, 218, 219 in an unsatisfactory manner: the connections requiring a more considerable cable length than in the first configuration 20.

This type of network of connections according to the prior art exhibits the drawback of leaving connectors left empty in certain cabin configurations. The empty connectors 201, 202, 203, 204, 206, 207, 208 may undergo deterioration. Moreover the relative separation of the connectors 201, 202, 203, 204, 206, 207, 208 and second rows 209, 210, 215, 216, 217, 218, 219 may lead to an deterioration of the cables linking the connectors 201, 202, 203, 204, 206, 207, 208 to the second rows 209, 210, 215, 216, 217, 218, 219.

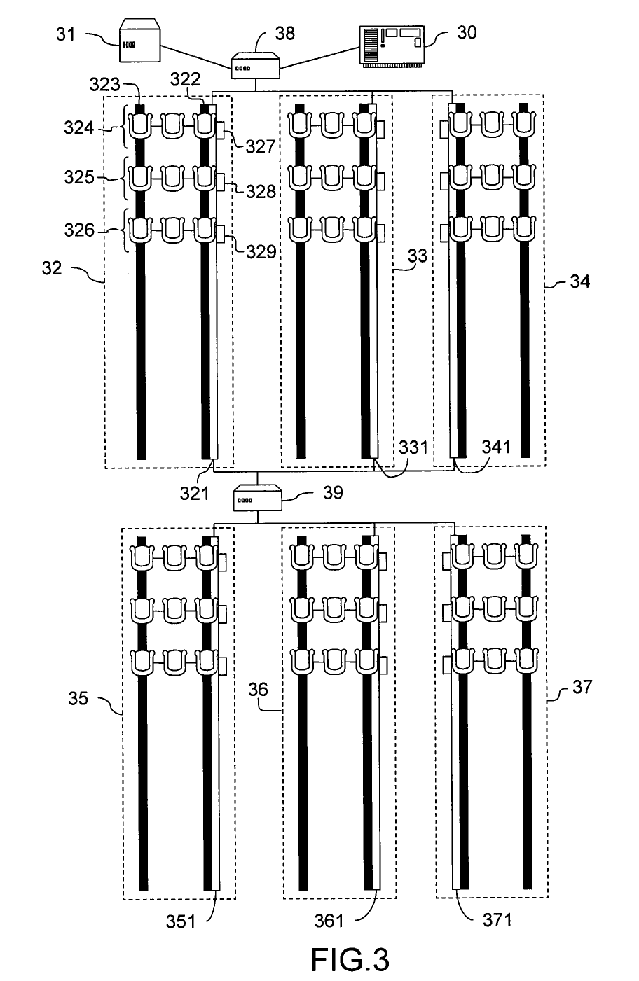

FIG. 3 schematically represents an energy and data transport network according to an embodiment of the invention. The energy and data transport network is a network allowing multimedia data transport and also energy transport to multimedia terminals. The multimedia data transport involves a signal comprising computer data. Hereinafter, the energy and multimedia data transport network according to the invention is dubbed network of multimedia connections. Hereinafter, the case of a network of multimedia connections embedded onboard an aircraft transporting passengers is considered. The multimedia terminals may be either integrated, or autonomous, such as portable micro-computers. Integrated terminals can be for example screens, touch-sensitive or otherwise, integrated into a back of a seat of the aircraft. In the case of autonomous terminals, the latter can be linked to the network of multimedia connections by way of one or more connectors adapted on the one hand to the distribution of energy and on the other hand to the distribution of data.

The network of multimedia connections according to an embodiment of the invention is notably connected to at least one second server 30 for multimedia application data. The second server 30 can notably store videos, music files as well as computer applications required for playing the videos or music files. The multimedia data therefore contain a set of different type information.

The network of multimedia connections according an embodiment of to the invention can also be connected to at least one energy supply box 31 placed for example under the floor of the cabin of the aircraft. The power supply box 31 is for example connected to an onboard power supply network of the aircraft.

FIG. 3 depicts in a schematic manner an arrangement of an aircraft cabin interior. The interior of the aircraft cabin comprises for example six columns 32, 33, 34, 35, 36, 37 of seats, each comprising three rows 324, 325, 326 of three seats. Not all the rows 324, 325, 326 of seats of each column 32, 33, 34, 35, 36, 37 are represented so as not to overload FIG. 3. The six columns 32, 33, 34, 35, 36, 37 of seats are, for example, arranged as three first columns 32, 33, 34, behind which are three second columns 35, 36, 37. The three second columns 35, 36, 37 are arranged in alignment with the three first columns 32, 33, 34. This arrangement is given solely by way of example; other cabin arrangements are possible. Hereinafter, only the structure of the first column 32 and of the associated network of multimedia connections are described, the structures of the other columns 33, 34, 35, 36, 37 and of the associated network of multimedia connections being identical. The rows 324, 325, 326 of seats are for example mounted in a removable manner on two mutually parallel fixing rails 322, 323. The two fixing rails 322, 323 are fixed to the structure of the aircraft. The rows 324, 325, 326 are almost perpendicular to the fixing rails 322, 323. The two fixing rails 322, 323 are for example fixed to the two ends of the rows 324, 325, 326. Each column 32, 33, 34, 35, 36, 37 has a multimedia connection rail 321, 331, 341, 351, 361, 371. Each multimedia connection rail 321, 331, 341, 351, 361, 371 is connected to an interconnection box 38, 39. A first interconnection box 38 ensures notably an interconnection of each multimedia connection rail of the first rows 321, 331, 341, with on the one hand the power supply box 31, and on the other hand the second server 30. A second interconnection box 39 can ensure a connection between first multimedia connection rails 321, 331, 341 belonging to the first columns 32, 33, 34, and second multimedia connections rails 351, 361, 371 belonging to the second columns 35, 36, 37. The connections of the multimedia connection rails 321, 331, 341, 351, 361, 371 and of the interconnection boxes 38, 39 are effected in a preferential manner on one of the ends of the multimedia connection rails 321, 331, 341, 351, 361, 371. The interconnection boxes 38, 39 play the role of information and energy routers.

The multimedia connection rails 321, 331, 341, 351, 361, 371 can be mounted in a manner parallel to one of the fixing rails 322, 323. Thus, each multimedia connection rail 321, 331, 341, 351, 361, 371 may adjoin a fixing rail 322, 323 as represented in FIG. 3. In another embodiment, each multimedia connection rail 321, 331, 341, 351, 361, 371 may be integrated into a fixing rail 322, 323.

Each multimedia connection rail 321, 331, 341, 351, 361, 371 can provide energy and multimedia data to a limited number of seats, for example between four and eight rows of three seats. A limitation in the number of seats supplied by a multimedia connection rail 321, 331, 341, 351, 361, 371 advantageously makes it possible to offer electrical power and multimedia data throughput sufficient for each seat.

Each row 324, 325, 326 comprises notably equipment or multimedia terminals integrated into each seat. The multimedia equipment of each seat is linked to a first multimedia connection rail 321 by way of a connection module 327, 328, 329. For example the multimedia equipment of a first column 32 is connected to the first multimedia connection rail 321 by way of a first connection module 327. In the same manner, multimedia equipment of a second column 33 is connected to the first multimedia connection rail 321 by way of a second connection module 328. And, multimedia equipment of a third column 34 is connected to the first multimedia connection rail 321 by way of a third connection module 329. The connection modules 327, 328, 329 are described in greater detail subsequently. A link between the connection modules 327, 328, 329 and the multimedia equipment can be ensured by cables passing through structures of the seats of each row 324, 325, 326. Thus, the connection modules 327, 328, 329 can be mounted in a rigid manner on a row 324, 325, 326 or left floating at the end of a cable of small length.

The connection modules 327, 328, 329 can be connected to the first multimedia connection rail 321 at any point of the latter. This allows great flexibility in the arrangement of the rows 324, 325, 326 and for the spacing between two consecutive rows 324, 325, 326.

The multimedia connection rails 321, 331, 341, 351, 361, 371 can offer a ready to use connection or, according to the term of the art, plug and play.

The energy transmission by the multimedia connection rails 321, 331, 341, 351, 361, 371 may call upon a conventional method of conducting contacts on conducting materials. In this case, several choices may be possible:
link the rail electrically to the aircraft so as to decrease a step voltage should the aircraft be struck by lightning;
electrically insulate the rail of the aircraft so as to avoid possible corrosion problems;
not seek any of the above configurations.

The transmission of information, that is to say of multimedia data, may be performed in three ways:
a first approach can use conducting contacts on conducting materials; within the framework of the first approach, the conducting materials can be the same as for the energy transmission or other specialized materials;
a second approach can use radioelectric coupling by a magnetic or electric field in a waveguide;
a third approach can use a piezo-electric deposition transmitting a surface wave on the multimedia connection rail 321, 331, 341, 351, 361, 371.
   Examples of these various approaches for transporting data by the multimedia connection rail 321, 331, 341, 351, 361, 371 are explained hereinafter.

The length of each multimedia connection rail 321, 331, 341, 351, 361, 371 makes it possible for example to serve four to twelve rows 324, 325, 326 of three seats each, depending on the spacing between the rows 324, 325, 326.

An objective of the multimedia connection rail 321, 331, 341, 351, 361, 371, according to an embodiment of the invention, is to have feed capabilities:
as regards electrical power, from several hundreds of watts to several kilowatts, i.e. a typical available power of ten to a hundred watts for the multimedia equipment of each seat;
as regards possible data throughput, in a range of from a hundred megabits to more than a gigabit per second, making it possible to deliver a capacity of from a few megabits to more than ten megabits per second for the multimedia equipment of each seat.

As a function of the throughput margins, the information arising from the second server 30 may be fed directly to each interconnection box 38, 39 by a specific cable or else fed from connection rails 321, 331, 341, 351, 361, 371 to connection rails 321, 331, 341, 351, 361, 371 as represented in FIG. 3.

Each connection rail 321, 331, 341, 351, 361, 371 can be terminated at each of its ends by:
a load eliminating reflections of the computer signal at the rail end according to a technology adapted to the structure of the connection rail 321, 331, 341, 351, 361, 371;
a first connection probe, not represented, communicating to an external network, either directly in the form of an analogue signal, the associated electronics being located in the interconnection box 38, 39, or secured to a connection box of the rail going to an ordinary interface;
at least one connection to a power supply.
   An advantage in using a probe connected directly to a direct connection to an external network is simplicity of implementation and lower cost of making the connection rail 321, 331, 341, 351, 361, 371. An advantage in using a probe secured to a connection box of the rail is that of obtaining routing means with high upgrade potential as well as versatile routing and communication means.

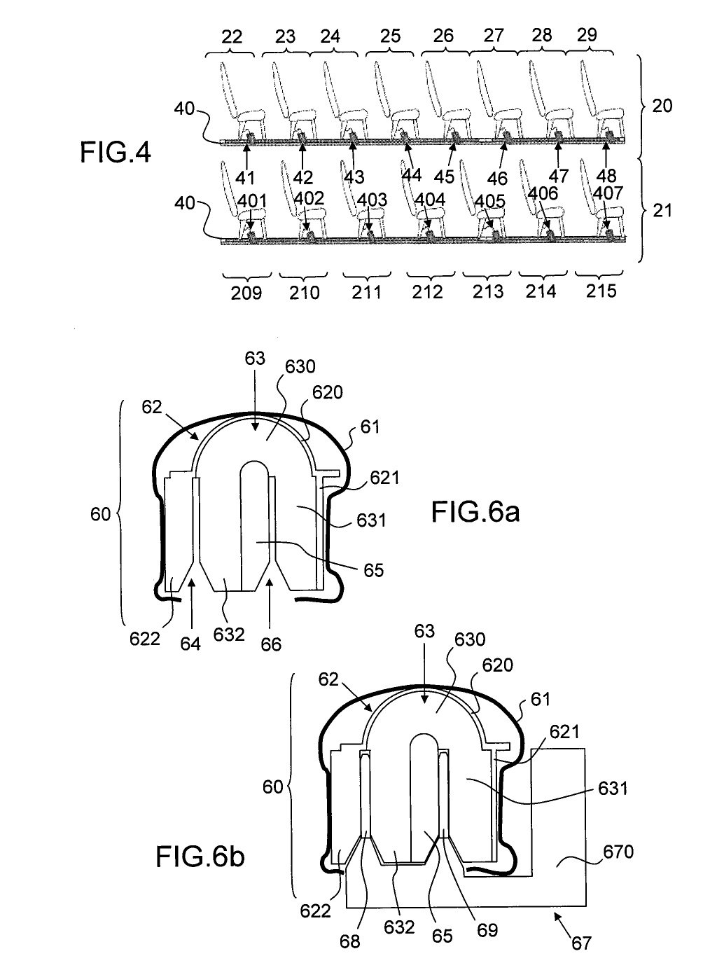

FIG. 4 represents two possible configurations 20, 21 of a cabin of an aircraft with a communication network such as represented in FIG. 2. The two configurations 20, 21 are adapted with a network of connections according to an embodiment of the invention comprising notably a second multimedia connection rail 40 according to an embodiment of the invention. The second multimedia connection rail 40 is of the same type as the multimedia connection rails 321, 331, 341, 351, 361, 371 represented in FIG. 4. A connection between the second multimedia connection rail 40 and the terminals of each seat of each of the first and second rows 22, 23, 24, 25, 26, 27, 28, 29, 209, 210, 215, 216, 217, 218, 219 is performed by way of connection modules 41, 42, 43, 44, 45, 46, 47, 48, 401, 402, 403, 404, 405, 406, 407. The connection modules 41, 42, 43, 44, 45, 46, 47, 48, 401, 402, 403, 404, 405, 406, 407 are such as the connection modules 327, 328, 329 represented in FIG. 3. A connection of a connection module 41, 42, 43, 44, 45, 46, 47, 48, 401, 402, 403, 404, 405, 406, 407 may advantageously be effected at any point of the second multimedia connection rail 40. The connection modules 41, 42, 43, 44, 45, 46, 47, 48, 401, 402, 403, 404, 405, 406, 407 are therefore independent of the structure of the aircraft and adaptable to various configurations of the cabin of the aircraft. Thus, in the first configuration 20, the number of first connection modules 41, 42, 43, 44, 45, 46, 47, 48 used is equivalent to the number of first rows 22, 23, 24, 25, 26, 27, 28, 29 present. Each of the first connection modules 41, 42, 43, 44, 45, 46, 47, 48 can therefore be mounted so as to be in immediate proximity to one of the first rows 22, 23, 24, 25, 26, 27, 28, 29 that it supplies. Thus in the second configuration 21, comprising one row less than the first configuration 20, the number of second connection modules 401, 402, 403, 404, 405, 406, 407 is lower than the number of first connection modules 41, 42, 43, 44, 45, 46, 47, 48. The second connectors 401, 402, 403, 404, 405, 406, 407 are therefore mounted in immediate proximity to each second row 209, 210, 215, 216, 217, 218, 219 without leaving any connection module unused. The cables between the rows 22, 23, 24, 25, 26, 27, 28, 29, 209, 210, 215, 216, 217, 218, 219 and the connection modules 41, 42, 43, 44, 45, 46, 47, 48 may advantageously be sufficiently short as not to undergo deteriorations.

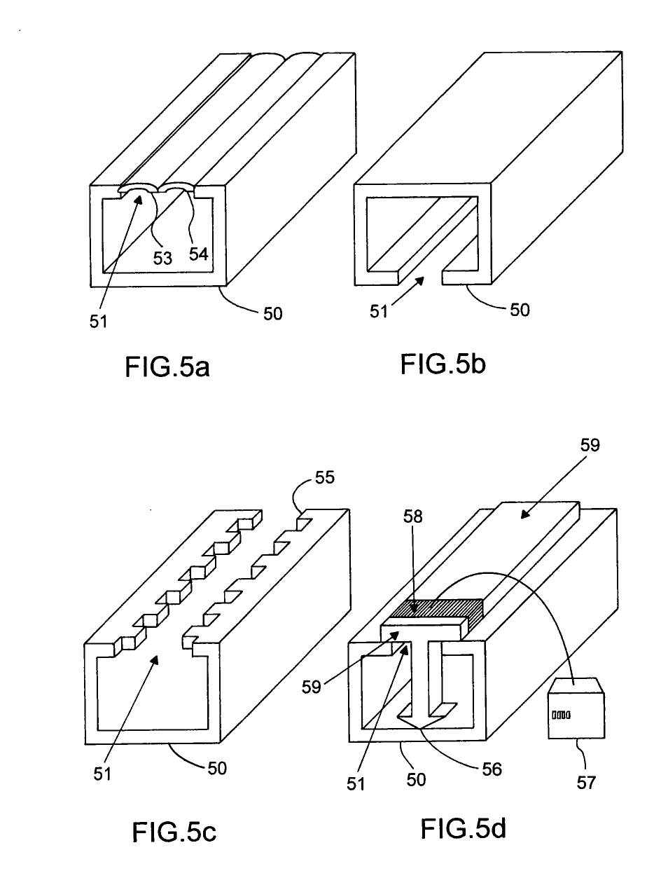

FIGS. 5a, 5b, 5c, 5d schematically represent possible embodiments of a multimedia connection rail 50 according to an embodiment of the invention.

The multimedia connection rail 50 according to an embodiment of the invention may notably be made of a contoured material, split over the whole of its length to allow insertion of one or more connection probes, one connection probe forming part of a connection module.

The multimedia connection rail 50 according to an embodiment of the invention may for example exhibit a U-shaped cross section. A slot 51 made in the connection rail 50 can be protected in various ways so as to avoid the dirtying of the latter.

A first procedure for protecting the slot 51 is represented in FIG. 5a. The first protection of the slot 51 can be effected by two lips 53, 54 situated inside the slot 51 each being secured to the connection rail 50. The two lips 53, 54 can be made with at least one resilient material. The two lips 53, 54 can be arranged so as to close the slot 50. The two lips 53, 54 may splay out so as to make way for a second connection probe. The structure of the second connection probe can itself comprise means for masking the opening generated by the second probe between the two lips 53, 54, so as to guarantee protection of the interior of the rail against dust or other elements originating from outside.

A second procedure for protecting the slot 51 is represented in FIG. 5b. The second protection procedure can be carried out by placing the slot 51 facing the flooring. This makes it possible to prevent impurities from falling into the slot 51.

In another embodiment, the slot can be placed facing the flooring and plugged by two lips 53, 54 such as represented in FIG. 5a.

In FIG. 5c, an embodiment of the connection rail 50 comprises a notching system 55. The notching system 55 is placed in the slot 51. The notching system 55 is composed of a series of holes arranged at regular intervals. The holes of the notching 55 are adapted to the shape of a second connection probe. A spacing between two consecutive holes of the notching 55 is chosen to be small, of the order of five to ten centimetres for example, so as to provide numerous connection points. The notching system 55 allows correct positioning of the second connection probe in the connection rail 50 while leaving a considerable number of connection points.

FIG. 5d represents the connection rail 50 associated with the second connection probe 56 represented in a schematic manner. The connection modules 327, 328, 329, 41, 42, 43, 44, 45, 46, 47, 48, 401, 402, 403, 404, 405, 406, 407 represented in FIGS. 3 and 4 comprise notably:
the second connection probe 56 immersed in the longitudinal slot 51 of the connection rail 50; the second connection probe 56 ensures notably the couplings in terms of energy and information of the rail and multimedia terminals;
an electronic box 57 situated in immediate proximity to the second connection probe 56; the electronic box 57 limits notably disturbances of the computer signal that are caused by the presence of the second connection probe 56 in the connection rail 50; the electronic box 57 also ensures correct transmission of energy and information to the multimedia equipment; the electronic box 57 can comprise notably electronic interfaces for amplifying and reshaping the computer signal;
a masking and latching system 58 associated with the second connection probe 56; the masking and latching system 58 makes it possible to facilitate the insertion of the second connection probe 56 into the connection rail 50; the masking and latching system 58 also makes it possible to ensure mechanical protection of the second connection probe 56 and to ensure the holding in place in the rail 50 of the second connection probe 56.
   The connection module composed in this way according to an embodiment of the invention can be either mounted in a rigid manner at an end of a row of seats or left free at the end of a cable of small length.

Also represented in FIG. 5d are means for protecting the spaces of the slot 51 that are left free by the second connection probe 56. These means may be hideaways 59, positioned on the slot 51, shutting off the latter.

The second connection probe 56 is electrically in contact with the rail 50. The electrical contacts of the second connection probe 56 have notably the following characteristics:
disturb the characteristic impedance of the rail 50 as little as possible and avoid modifying the separation distance of the conductors making up the rail 50;
intercept surface currents created by the computer signal while disturbing them as little as possible;
have a sufficient cross section to transmit the power supply current;
avoid deterioration of the rail 50 pursuant to successive connections and disconnections.

FIGS. 6a and 6b represent a first embodiment of the connection rail 50 and of the second connection probe 56 according to an embodiment of the invention. The first embodiment of the connection rail 50 is a conducting rail with open coaxial structure 60.

The coaxial rail 60 comprises an elastic external structure 61. The external structure has notably a U shape encompassing an internal structure of the coaxial rail 60. The elastic external structure 61 is notably able to deform so as to be able to splay out during the introduction of contacts 68, 69 of a third connection probe 67 represented in FIG. 6b. The external structure 61 is notably able to regain its initial shape after the contacts 68, 69 of the third connection probe 67 are withdrawn. The external structure 61 thus plays a role of closure spring for the coaxial rail 60. The external structure 61 may comprise an insulating sheet.

Inside the external structure 61, the coaxial rail 60 comprises an internal structure composed notably of a conductor 62, termed the neutral conductor. The conductor 62 is at a constant potential equivalent to ground. For example the conductor 62 can be at equipotential with the structure of the aircraft. The conductor 62 can notably be U-shaped.

The conductor 62 can, in a first embodiment, be composed of several parts 620, 621, 622, as represented in FIGS. 6a and 6b.

A first part 620 of the conductor 62 can be of semi-circular cross section with two edges on each side.

A second part 621 of the conductor 62 can be of parallelepipedal shape. The second part 621 of the conductor 62 is in contact electrically and mechanically with a first edge of the first part 620 of the conductor 62. The second part 621 is able to perform a translation along the first edge of the first part 620 of the conductor 62 while remaining in mechanical and electrical contact with the first part 620 of the conductor 62.

A third part 622 of the conductor 62 can be of parallelepipedal shape. The third part 622 of the conductor 62 is in contact electrically and mechanically with a second edge of the first part 620 of the conductor 62. The third part 622 is able to perform a translation along the second edge of the first part 620 of the conductor 62 while remaining in contact mechanically and electrically with the first part 620 of the conductor 62.

The conductor 62 can, in a second embodiment (not represented), be composed in one part of a flexible material in a U shape. In a third embodiment not represented, the conductor 62 can be the external structure 61.

The internal structure of the coaxial rail 60 can comprise a first insulant 63 whose cross section is U-shaped, situated inside the conductor 62.

The first insulant 63, in the first embodiment, can be composed of three parts 630, 631, 632, as represented in FIGS. 6a and 6b.

A first part 630 of the first insulant 63 can have a U-shaped cross section. The first part 630 of the first insulant 63 is notably in mechanical contact with the first part 620 of the conductor 62.

A second part 631 of the first insulant 63 can be parallelepiped-shaped. The second part 631 of the first insulant 63 is in contact with the first part 630 of the first insulant 63. The second part 631 of the first insulant 63 is able to perform a translation with respect to a first edge of the first part 630 of the first insulant 63 while remaining mechanically in contact with the first edge of the first part 630 of the first insulant 63. The first edge of the first part 630 of the first insulant 63 is for example an end of a first leg of the U forming the first part 630 of the first insulant 63. The second part 631 of the first insulant 63 is mechanically in contact with the second part 621 of the conductor 62. The second part 631 of the first insulant 63 can move with the second part 621 of the conductor 62.

A third part 632 of the first insulant 63 can be secured to the first part 630 of the first insulant 63. The third part 632 of the first insulant 63 can notably be in contact with a second edge of the first part 630 of the first insulant 63. The second edge of the first part 630 of the first insulant 63 is for example an end of a second leg of the U forming the first part 630 of the first insulant 63. The third part 632 of the first insulant 63 is notably parallel to the third part 622 of the conductor 62. The third part 632 of the first insulant 63 is notably separated from the third part 622 of the conductor 62 by a first space 64 allowing the introduction of a first contact 68 of the third connection probe 67, such as represented in FIG. 6b.

In the second embodiment, the first insulant 63 can be composed of a flexible part, able to deform so as to receive the contacts 68, 69 of the third connection probe 67.

The internal structure of the coaxial rail 60 can also comprise a first internal conductor 65. The first internal conductor 65 is termed the live of the coaxial rail 60: it emits notably a high-frequency radiation and it conveys a variable voltage. The first internal conductor 65 is of parallelepipedal format. A first end of the first internal conductor 65 is in mechanical contact with the first part of the first insulant 63. A first face of the first internal conductor 65 is in mechanical contact with the third part 632 of the first insulant 63. A second face of the first internal conductor 65 is substantially parallel with the second part 631 of the first insulant 63. The second face of the first internal conductor 65 is separated from the second part 631 of the first insulant 63 by a second space 66. The second space 66 allows insertion of a second contact 69 of the third connection probe 67, the second part 631 of the first insulant 63 splaying out to allow the introduction of the second contact 69 of the third connection probe 67 in the second space 66.

The first insulant 63 ensures galvanic isolation between the external conductor 62 and the first internal conductor 65. The construction of the first insulant 63 makes it possible to define a characteristic impedance of the coaxial line made up notably of the external conductor 62 and the first internal conductor 65. The definition of the characteristic impedance of the coaxial line makes it possible to determine the thickness of the first insulant 63 as a function of the permittivity of a material of which it is composed.

For example, only the first internal conductor 65 and the third part 632 of the first insulant 63 are made of solid materials. The other parts making up the internal structure of the coaxial rail 60 are not necessarily made of solid material, indeed, the other parts serve only to stabilize the characteristic impedance of the coaxial rail 60.

The coaxial rail 60 can be terminated at each of its ends by:
a resistance equal to the characteristic impedance of the coaxial line, with a capacitive coupling, not represented;
adaptation circuits and a connection to the routers and power supply converters, not represented.

FIG. 6b represents notably the third connection probe 67 comprising two contacts 68, 69. The two contacts 68, 69 are able to penetrate into the internal structure of the coaxial rail 60. Notably, the contacts 68, 69 have a donkey back shape allowing elastic deformation of the coaxial rail 60 and of its elements with a lesser deterioration of the impedance of the coaxial line.

The third connection probe 67 comprises an electronic connection box 670 making it possible to minimize the disturbances of the signal flowing in the coaxial rail 60. The characteristic impedance of the coaxial line is therefore hardly disturbed by the presence of the third connection probe 67. This makes it possible to have a considerable bandwidth for the signal in the coaxial rail 60. The electronic connection box 670 is notably placed in a manner parallel to the coaxial rail 60.

The first embodiment of the connection rail 50 has the advantage of offering a cheap, compact and flexible connection rail 50. It is possible for example to curve the connection rail 50 by about ten degrees.

Furthermore, the connection rail 50 according to the first embodiment shows evidence of good resistance to dust and to the various constraints both climatic and mechanical.

The first embodiment of the connection rail 50 according to an embodiment of the invention also allows a data throughput of a few gigabits per second.

Initially, a data transmission protocol used with the coaxial rail 60 may be a variant of a basic point-to-point protocol, with multi-access points.

Whatever embodiment is chosen for the coaxial rail 60, certain design rules are common to all the embodiments.

A first rule to be taken into account in the design of a coaxial rail 60 relates to the data transmission function of the coaxial rail 60. Specifically, the coaxial rail 60 has a defined characteristic impedance, coming into play notably when choosing the thickness of the insulating materials used in the coaxial rail 60. This impedance is chosen so as to obtain a good compromise between several advantages:
the main advantages of low impedance are notably:
   allows use of an insulating material of lower thickness thus rendering the coaxial rail 60 more compact;
   allows use of a dielectric with a lower permittivity, for example semi aerated, while preserving a constant thickness of the first insulant 63, this making it possible to decrease the losses in the coaxial rail 60;
   makes it possible, by preserving a constant bandwidth, to obtain lesser sensitivity to parasitic elements related to the capacitance or more generally to the impedance of the first connection probes 67;
a more considerable impedance makes it possible, for constant noise immunity, to reduce the consumption of the third connection probe 67: for one and the same voltage, it is therefore preferable to provide less current;
an impedance of the order of fifty ohms makes it possible, in the laboratory, to test the structure of the coaxial rail 60 more easily.
   These advantages can therefore be taken into account when designing the coaxial rail 60 as a function of the results sought and of the context of use of the coaxial rail 60.

A second rule relates to a cross section of the conducting materials employed to allow the flow, with low losses, of considerable currents. This rule is also applicable to the third connection probe 67. The geometry of the internal and external conductors 65, 63 intervenes notably in a calculation of the characteristic impedance of the coaxial rail 60. Definition of the cross section of the internal and external conductors 65, 63, starting from the geometry of the internal and external conductors 65, 63, therefore makes it possible to define the thickness of the dielectrics used in the coaxial rail 60.

A third rule applicable to the coaxial rail 60 relates to the radiation originating from the coaxial rail 60 and reaching the latter. Specifically, signals internal to the coaxial rail 60 should not leave it and neither should any parasitic glitches be generated inside the rail. In the same manner, internal signals should not enter the rail. The thickness of a dielectric to define the characteristic impedance implies that there should not be multiple layers thereof. It is therefore judicious to choose, for the coaxial rail 60, asymmetric line structures akin to coaxial structures. It is also possible to choose a symmetric structure as a shielded two-wire line, on condition however that the insulation is doubled.

A fourth rule relates to a computer signal transporting the multimedia data. The computer signal flows notably at the surface of the conductors 63, 65 facing opposite in the coaxial rail 60. To this end, it is preferable for the resistance of the surface of the conductors to be very low. This therefore requires:
either covering the surface of the coaxial rail 60 with a material of very high conductivity, for example a gilding, resistant to corrosion, or with a material whose corrosion products have a very high conductivity themselves;
or covering the surface of the coaxial rail 60 with a material, for example aluminium, so as to produce a low-loss dielectric layer ensuring anticorrosion protection of the surface of the material; this can be carried out by an anodization method for example.

A fifth rule applicable to the coaxial rail 60 is that the coaxial rail 60 is advantageously robust, simple to manufacture, to install and to connect.

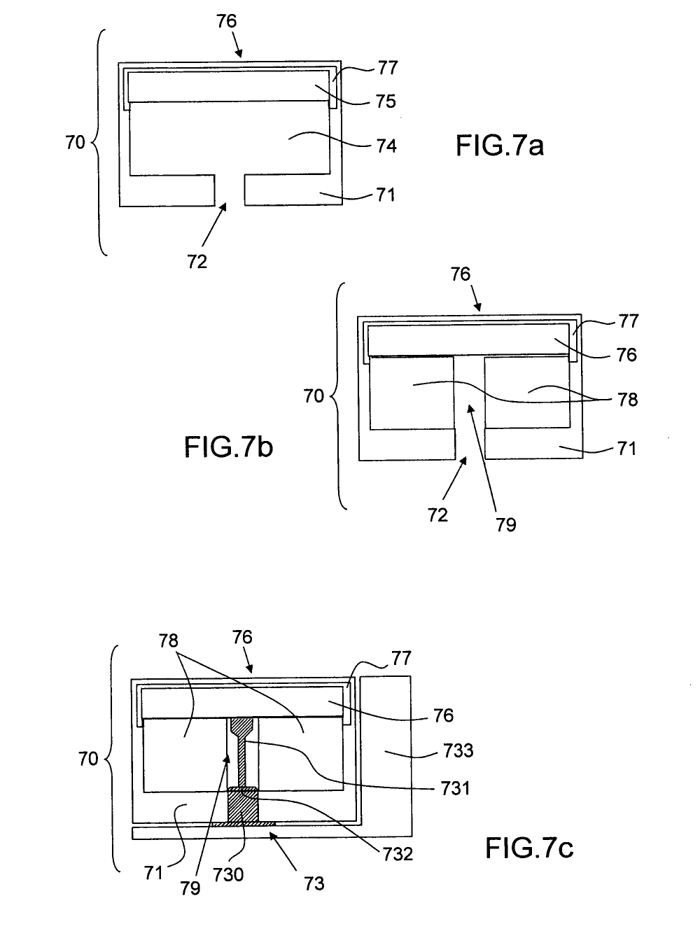

FIGS. 7a, 7b, 7c represent a second embodiment of the connection rail 50 and of the second connection probe 56 according to an embodiment of the invention. The second embodiment of the connection rail 50 is a rail with waveguide structure 70.

The waveguide rail 70 therefore possesses a contour of a rectangular waveguide 71, split at its middle in the length-wise direction.

The waveguide rail 70 comprises a conducting rectangular contoured member 71. The conducting rectangular contoured member 71 plays the role of neutral in the waveguide rail 70. A first face of the conducting contoured member 70 comprises a slot 72, similar to the slot 51 represented in FIG. 5b. The slot 72 allows the penetration into the conducting contoured member 71 of a fourth connection probe 73 represented in FIG. 7c. The face of the conducting contoured member 71, comprising the slot 72, can be dimensioned to transport a continuous current. The exterior of the conducting contoured member 71 can be covered with a layer of an insulating material. The conducting contoured member 71 comprises an interior space 74. If required, the slot 72 can be partially plugged by a conducting flexible seal, made for example of cupro-berylium or stainless steel. Such a seal furthermore allows protection against dust of the interior space 74.

In its interior space 74, the conducting contoured member 71 comprises a second internal conductor 75. The second conductor 75 plays the role of live in the waveguide rail 70. The second internal conductor 75 is for example of parallelepipedal shape and extends over a second face 76 of the conducting contoured member 70. The second face 76 of the conducting contoured member 71 is an opposite face from the slot 72. The second internal conductor 75 entirely covers the second face 76 of the conducting contoured member 71.

An insulating sheet 77 can notably cover the interior of the second face 76 of the conducting contoured member 71, opposite from the slot 72. The insulating sheet 77 is situated between the second face 76 of the conducting contoured member 71 and the second internal conductor 75. The insulating sheet 77 therefore entirely insulates the second face 76 of the conducting contoured member 71, of the second internal conductor 75. The insulating sheet 77 provides galvanic isolation as well as high capacitance. The high capacitance of the insulating sheet 77 makes it possible for the conducting contoured member 71 and the second internal conductor 75 to be placed at the same potential at the operating frequencies of the waveguide rail 70.

The interior space 74 can comprise two dielectric bars 78 of parallelepipedal shape, a space 79 between the two dielectric bars 78 being left free in the interior space 74 along the extension of the slot 72 so as to allow the fourth connection probe 73 to pass as far as the second internal conductor 75. The space 79 left free makes it possible to reduce the dimensions of the waveguide rail 70 while having a constant bass-cut frequency. A waveguide rail 70 thus loaded, represents an equivalent of a waveguide of double-wall type having in particular a butterfly-like equivalent electrical profile. The dielectric bars 78 are notably of progressive permittivity type for impedance matching. Among the various embodiments of dielectrics with progressive permittivity, it is possible to choose the use of stacked dielectric wafers.

In microwave-frequency operation, the space 79 left free constitutes a waveguide. By adapting the geometries of the conducting contoured member 71 and of the second internal conductor 75, as well as by adapting the permittivity of the dielectrics 78, it is possible to transform the rectangular waveguide rail 70 into a single-wall or double-wall waveguide. A double-wall waveguide advantageously possesses a broader bandwidth.

Each end of the waveguide rail 70 allows linkup to a power supply and to a means of coaxial transition to the routing equipment.

FIG. 7c represents the fourth connection probe 73. The fourth connection probe 73 can comprise a coaxial probe with piston 73. The coaxial probe with piston 73 comprises notably a first external contact 730. The first external contact 730 bears on an external face of the conducting contoured member 71 or on the edge of the slot 72. The first external contact 730 is a g round contact. The coaxial probe with piston 73 comprises a second internal coaxial contact 731, mounted on a spring-loaded piston for example. The internal coaxial contact 731 bears for example on the second internal conductor 75. The internal coaxial contact 731 can be linked to the coaxial probe 73 by passing through the first external contact 730. A coaxial insulant 732 is, for example, slipped between the internal coaxial contact 731 and the external contact 730. As in FIG. 7a, the coaxial probe 73 can comprise an electronic connection box 733. In order to reconcile a constraint of low electromagnetic disturbance of the waveguide rail 70 and a constraint of transporting a heavy amperage, it is possible to place several fourth connection probes 73 in line.

Any suitable data transmission protocol can be used. Initially, a protocol can be defined according to the IEEE 802.16 standard or more generally according to a WIMAX standard. An optional frequency translation may be used, if the dimensions of the waveguide rail 70 are incompatible with the range of the frequencies used in a standardized manner for propagation in free space. WIMAX is a trademark, registered under the number 0058300229, by WIMAX Forum.

The main advantages of the second embodiment of the connection rail 50 according to the invention are:
a very high bandwidth limit;
a very high data throughput, making it possible to link a considerable number of rows on one and the same waveguide rail 70;
electronic components for interfacing between the waveguide rail 70 and the pre-existing routers, that can be used at lesser cost.

A design of a waveguide rail 70 can take several parameters into account.

A first design parameter of the waveguide rail 70 is the operating frequency band. The frequency band makes it possible to define:
internal dimensions of the guide and therefore its bulkiness;
a technological level and therefore a cost for the interface microwave-frequency components carrying the signal;
a potential throughput in the guise of digital transmission channel of the waveguide rail 70, the frequency band being for this purpose taken in association with the technologies used for the coding.

A second design parameter is the design of the faces of the waveguide rail 70. Two options exist notably:
a first option is to embody the faces of the waveguide rail as a mirror, that is to say a metallic wall with high surface conductivity;
a second option is to use a material with much lower permittivity than that of the interior of the guide, thus ensuring a total reflection on the interface.

The first option is optimal for centimetre frequencies, of the order of two to eighteen gigahertz. Numerous pre-existing components are already suitable for these frequencies, thereby making it possible to reduce the cost of producing the waveguide rail 70.

The second option corresponds to the millimetre frequency region. In the millimetre frequency region, the throughputs are high. It is advantageously possible to use a cheap waveguide rail 70 of small dimensions.

Mixed solutions, combining the first option and the second option, are also possible. The mixed solutions use notably dielectric guides of the electrical image by conducting mirror type.

A third parameter to be taken into account in the design of the waveguide rail 70 is that it should not behave as a radiating antennal structure. That is to say the internal signals, the computer signals and also parasitic residuals, should not leave the waveguide rail 70. Moreover, external signals should not be able to enter the waveguide 70. A main origin of spurious residuals is notably related to the presence of various switched power supplies of the communication system. To alleviate these spurious residuals, it is possible notably:
to ensure a very high filtering level, by fitting for example one filter per item of electronic equipment, this making it possible notably to leave total freedom with respect to the relative positioning of the energy conductors 71, 76 in the waveguide rail 70;
to construct the waveguide rail 70 in such a way that the energy conductors 71, 76 are enclosed in a common shielding structure making it possible to use pre-existing means in accordance with the standards in force in this sector, notably the CENELEC standard.
   The waveguide rail 70 should not radiate too high a continuous magnetic field so as not to run the risk of disturbing the onboard instruments. Moreover, the cross section of the conductors should make it possible to transport a high current.

A fourth parameter to be taken into account in the case of a metallic waveguide rail 70 is the surface resistance. The surface resistance is necessarily low. This requires:
either covering the surface with a material of very high conductivity, for example a gilding, resistant to corrosion or whose corrosion products have a very high conductivity themselves;
or covering the surface material of the waveguide 70 with a layer of low-loss dielectric, for example aluminium, ensuring anticorrosion protection of the surface, for example by anodization. This solution is applied to the parts of the surface having no electrical contact with another surface.

A fifth parameter to be taken into account is that the electrical contacts of the second probes 73:
disturb the internal field of the waveguide rail 70 as little as possible by creating the fewest possible standing waves, while coupling up correctly;
have a sufficient cross section to transmit a power supply current;
do not impair the waveguide rail 70 pursuant to successive connections, disconnections for as long as possible.

A sixth parameter to be taken into account is a robustness of the waveguide rail 70 which is also advantageously easy to manufacture, to install and to connect.

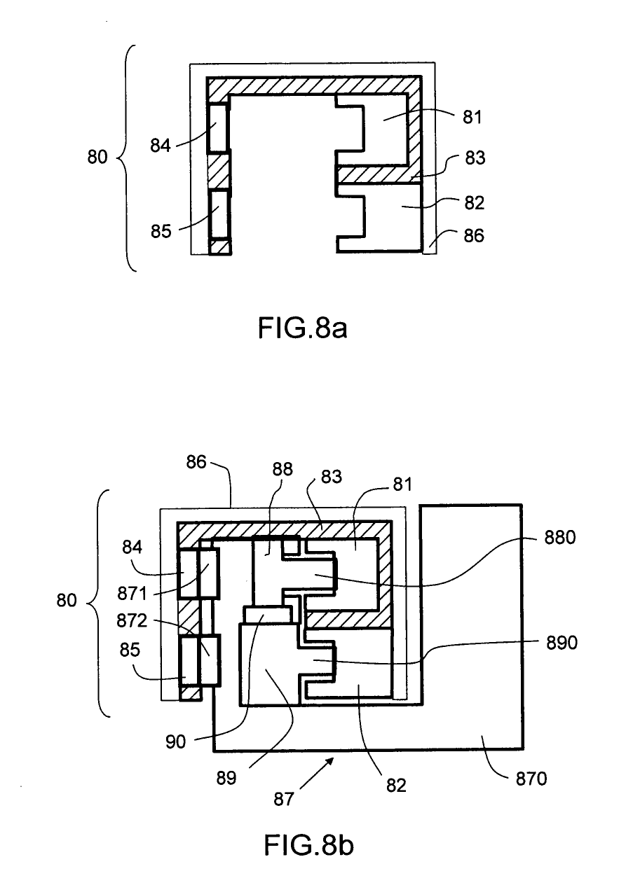

FIGS. 8a and 8b represent a third embodiment of the connection rail 50 and of the second connection probe 55 according to the invention. The connection rail 50 can be embodied by a so-called surface-wave rail 80.

The surface-wave rail 80 comprises notably one or more conductors 81, 82. FIGS. 8a and 8b represent for example two conducting bars 81, 82. The two conducting bars 81, 82, can be separated from one another by a second insulant 83. The second insulant 83 ensures galvanic isolation of the conductors 81, 82. The second insulant 83 can be embodied by a polymer material.

The surface-wave rail 80 also comprises one or more strips of piezo-electric materials 84, 85. The piezo-electric strips form for example two piezo-electric tracks 84, 85 making it possible to propagate a mechanical surface wave. The bandwidth of the computer data transmitted is distributed over the piezo-electric tracks 84, 85. The second insulant 83 can ensure protection and mechanical damping between the piezo-electric tracks 84, 85.

An external mechanical structure 86 of the surface-wave rail 80 ensures the shielding of the surface-wave rail 80. The external structure 86 is for example a U-shaped contoured member as represented in FIGS. 8a, 8b. The piezo-electric tracks 84, 85 are placed side by side on a first internal face of the external structure 86. On a second internal face of the external structure 86, situated facing the first internal face, are situated the conducting bars 81, 82. The two conducting bars 81, 82 can be placed side by side. A first conducting bar 82 can be secured mechanically to the external structure 86. A second conducting bar 81 can be insulated from the external structure 86 and from the first conducting bar 82 by the second insulant 83. The second insulant 83 is therefore on the one hand applied between the two conducting bars 85, 86 and on the other hand between the second conducting bar 81 and the external structure 86. The second insulant 83 can also be applied between the two piezo-electric tracks 84, 85 and between the piezo-electric tracks 84, 85 and the external structure 86.

FIG. 8b represents an example of a fifth connection probe 87 able to be connected with the surface-wave rail 80. The fifth connection probe 87 ensures notably a coupling with the surface-wave films, that is to say with the piezo-electric strips 84, 85. The fifth connection probe 87 also ensures electrical linkup with the conductors 81, 82. The coupling of the fifth connection probe 87 with the surface-wave films 84, 85 can be done through transducers 871, 872 of several technologies:
piezo-electric transducers;
magnetostrictive transducers;
electrostatic or electrodynamic transducers, for example based on MEMS, the acronym standing for Micro-Electro-Mechanical Systems.
   The transducers 871, 872 are secured to the fifth connection probe 87. The transducers 871, 872 are placed on the fifth connection probe 87 so as to be respectively in contact with a piezo-electric track 84, 85 once the fifth connection probe 87 has been positioned in the surface-wave rail 80. Electrical linkup between the fifth connection probe 87 and the conducting bars 81, 82 can be done in several way. For example, it is possible to use a fifth connection probe 87 with cam-based latching 880, 890 as represented in FIG. 8b. To this end, a groove is made in each of the two conducting bars 81, 82. The fifth connection probe 87 comprises notably two coaxial power conductors 88, 89. A first power conductor 88 comprises a first contact cam 880 for latching on the second conducting bar 81. A second power conductor 89 comprises a second contact cam 890 for latching on the first conducting bar 82. The first power conductor 89 is insulated from the second power conductor by a third insulant 90. On inserting the fifth connection probe 87 into the surface-wave rail 80, the two cams 880, 890 of the conductors 88, 89 are in a longitudinal orientation with respect to the U-shaped structure of the surface-wave rail 80. Thereafter the two cams 880, 890 ensure, by their rotation, precise positioning in relation to the conducting bars 81, 82. The two cams 880, 890, when they are in position in the surface-wave rail 80, also ensure that the transducers 871, 872 exert pressure on the piezo-electric tracks 84, 85.

Transmission of the computer data is possible by superimposing the computer signal containing the data on the power supply voltages, for example for signalling functions.

A surface-wave rail 80 possesses several advantages:
good immunity to noise making it possible to envisage tight constellation modulations;
possibility of being able to create several transmission channels in parallel;
lightness and flexibility;
low sensitivity to dust or other rubbish.

The surface-wave rails, an example of which is represented in FIGS. 8a, 8b, have notably the characteristics described hereinafter. The piezo-electric track or tracks 84, 85 of materials conducting the computer data signals by surface wave can be deposited on a plane or convex material substrate, the said substrate possibly being folded back thereafter for insertion into a structure, such as the external structure 86. The external structure 86 can then ensure mechanical protection of the materials conducting the computer data signals. The substrate, aside from its mechanical characteristics, eliminates or minimizes:
undesirable modes of propagation, surface or bulk, of the computer data signals;
couplings between piezo-electric tracks 84, 85 if need be.

In order to ensure the electromagnetic compatibility of the surface-wave rail 80, several solutions are possible:
ensure a good filtering level, that is to say a level required in the aeronautics sector by adding a margin: this leaves total freedom as regards the relative positioning of the energy conductors 88, 89;
construct a surface-wave rail in such a way that one of the energy conductors 88, 89 serves as shielding for the other, or else that the two conductors 88, 89 are enclosed in a common shielding structure; the latter characteristic makes it possible to use products existing on the market complying with the GENELEC standard or equivalent.

The transducer or transducers 871, 872 can be inserted or withdrawn without damaging the piezo-electric surface or surfaces 84, 85. Once inserted into the connection probe 87, the transducers 871, 872 are coupled with the piezo-electric surfaces 84, 85 with a well defined optimized pressure. The transducers 871, 872 can ensure mechanical cleaning of the piezo-electric surfaces during connection or disconnection.

The electrical contacts, that is to say the conductors 88, 89 of the fifth connection probe 87, advantageously do not interfere with the propagation of the signal of surface-wave type, on account of good mechanical decoupling between the conductors 88, 89 and the piezo-electric tracks 84, 85. Moreover, the electrical contacts 88, 89 have a sufficient cross section to transmit a power supply current. The electrical contacts, in the same manner as the transducers 871, 872, advantageously do not impair the surface-wave rail 80 during successive connections and disconnections.

The surface-wave rail 80 is advantageously robust, easy to manufacture, to install and to connect.

The connection rail 50 according to an embodiment of the invention, through its constant transmission line structure, advantageously lets the signals flow freely inside the rail 50 at a large number of frequencies. This makes it possible to provide a bandwidth and power levels that amply cover the requirements currently preferable for multimedia terminals.

The various proposed structures of connection rail 50 advantageously possess a modularity allowing adaptation to various configurations. Such modularity makes it possible to support future technological upgrades, without modifying the structure of the connection rail 50.

The present invention may advantageously be applied in sectors other than avionics. For example, a multimedia connection rail such as this may be used in the railway sector, in coaches, ships, or for office networks as well as in cafés offering multimedia activities.

1. An energy and data transport network for multimedia terminals, the network connected to at least one data server and at least one energy supply box, the network comprising:
one or more energy and data transport rail;
a first interconnection box to interconnect a first energy and data transport rail, the data server and the energy supply box, wherein the first interconnection box routes data between the data server and the first energy and data transport rail, and routes energy between the energy supply box and the first energy and data transport rail; and
a connection module for at least one multimedia terminal, the connection module including a cable to link a predetermined point of the energy and data transport rail to the multimedia terminal.

2. The energy and data transport network according to claim 1, comprising:
a second energy and data transport rail;
a second interconnection box to interconnect the first energy and data transport rail and the second energy and data transport rail, wherein the second interconnection box routes data and energy between the first energy and data transport rail and the second energy and data transport rail.

3. The energy and data transport network according to claim 2, wherein the first interconnection box is connected to a first end of the first energy and data transport rail, and the second interconnection box interconnects a second end of the first energy and data transport rail to a first end of the second energy and data transport rail.

4. The energy and data transport network according to claim 1, wherein the connection module further comprises:
a connection probe mechanically and electrically in contact with an interior of the one or more energy and data transport rails, wherein the connection probe is configured to collect energy and data from the one or more energy and data transport rails, and the connection probe is further configured to transfer data on the one or more energy and data transport rails; and
an electronic box having interfaces for amplifying and shaping the data, wherein the electronic box facilitates transmission of energy collected by the connection probe.

5. The energy and data transport network according to claim 1, wherein each of the one or more energy and data transport rails comprises a contoured material having a slot over substantially the whole of its length.

6. The energy and data transport network according to claim 1, wherein each of the one or more energy and data transport rails has a U-shaped cross section.

7. The energy and data transport network according to claim 5, wherein the slot of the one or more energy and data transport rails is oriented towards a floor.

8. The energy and data transport network according to claim 5, wherein the slot of the one or more energy and data transport rails is closed by two lips made of a resilient material.

9. The energy and data transport network according to claim 5, wherein the slot comprises a notching system.

10. The energy and data transport network according to claim 1, wherein each of the one or more energy and data transport rails comprises at least first and second electrical conductors separated by an insulator, the first electrical conductor at a reference potential, and the second electrical conductor having a variable voltage.

11. The energy and data transport network according to claim 10, wherein a connection probe comprises at least two contacts, each contact mechanically and electrically in contact with one of the first and second electrical conductors.

12. The energy and data transport network according to claim 11, wherein each of the one or more energy and data transport rails has an open coaxial structure.

13. The energy and data transport network according to claim 12, wherein each of the one or more energy and data transport rails comprises an elastic external structure encompassing an internal structure comprising the first and second electrical conductors and the insulator, the first and second electrical conductors and the insulator deformable when first and second contacts of the connection probe are introduced into each of the one or more energy and data transport rails.

14. The energy and data transport network according to claim 11, wherein each of the one or more energy and data transport rails comprises one or more piezo-electric strips transmitting data by use of one or more surface waves.

15. The energy and data transport network according to claim 14, wherein the connection probe comprises one or more transducers in contact with the one or more piezo-electric strips.

16. The energy and data transport network according to claim 11, wherein each of the one or more energy and data transport rails has a waveguide structure.

17. The energy and data transport network according to claim 16, wherein the energy and data transport rail with waveguide structure comprises two bars composed of dielectric materials separated by a space, the space configured to provide access to the electrical conductors for two coaxial contacts of a coaxial connection probe, at least one of the two coaxial contacts mounted on a piston, the two coaxial contacts being insulated from one another by a coaxial insulator.

18. The energy and data transport network according to claim 1, wherein the connection module is configured to supply data and energy to touch-screens.

19. The energy and data transport network according to claim 1, wherein the connection module is configured to supply data and energy to personal portable computers.

20. The energy and data transport network according to claim 1, further comprising an interface to an external network.

21. The energy and data transport network according to claim 1, further comprising an interface to mount the network on board an aircraft.

22. The energy and data transport network according to claim 21, wherein the first and second energy and data transport rails are mounted on a floor of a cabin of the aircraft, in a manner substantially parallel to fixing rails of rows of passenger seats.
